(19) United States
(12) Patent Application Publication
(10) Pub. No.: US 2015/0068672 A1
(43) Pub. Date: Mar. 12, 2015

(54) METHOD OF MANUFACTURING A RADIO FREQUENCY IDENTIFICATION TAG INTEGRATED INTO AN ARTWORK

(71) Applicant: Chung Shan Institute of Science and Technology, Armaments Bureau, M.N.D, Taoyuan County (TW)

(72) Inventors: Ming-Tseh Tsay, Taoyuan County (TW); Seng-Min Chang, Taoyuan County (TW)

(73) Assignee: Chung Shan Institute of Science and Technology, Armaments Bureau, M.N.D, Taoyuan County (TW)

(21) Appl. No.: 14/022,567

(22) Filed: Sep. 10, 2013

(51) Int. Cl. G06K 19/077; B32B 38/10; B32B 37/02; B32B 37/24

(52) U.S. Cl. CPC G06K 19/0776; B32B 37/24; B32B 38/10; B32B 37/02; G06K 19/07722; B32B 2037/243
USPC 156/249

(57) ABSTRACT

A method for manufacturing an RFID tag integrated into an artwork includes steps of selectively coating a watertight layer on a periphery of the artwork; printing a conductive ink on a surface of a polyethylene terephthalate film; heating the printed conductive ink on the surface of the polyethylene terephthalate film, and curing the conductive ink as an antenna of the RFID tag; removing the antenna from the polyethylene terephthalate film to be packaged as the RFID tag with an RFID chip; pasting the RFID tag on the periphery of the artwork with AB adhesive provided on an interface between the RFID tag and the artwork; and coating a protective layer on a periphery of the RFID tag to prevent exposure to the air.

### BACKGROUND OF THE INVENTION

1. Field of the Invention

The present invention is related to an identification method for artworks, and more particular to a method of manufacturing a radio frequency identification (RFID) tag integrated into the pattern or the design of ceramics without changing the appearance thereof

2. Description of the Related Art

Identifying if artworks are genuine or fake is one of important tasks in artwork appraisal as a gigantic price gap exists between a genuine one and a fake one, and the fake one could be usually sold by the unscrupulous trader for the resulting huge profit. Hence, identification for artwork becomes a critical job in protecting buyers against counterfeit and fraudulent art.

Usually, art forgery can be identified by contrast in details like pattern, color and signature presented on the artwork, or can be identified by an X-ray image showing tiny details in a forged artwork to distinguish the forged artwork from the original one. Further, the material of an artwork can be analyzed and compared with that of the origin artwork to determine the authenticity of artwork.

However, those above-mentioned conventional identification methods may take a long time to complete artwork identification, while the detailed analysis of an artwork may be inadvertently ignored during the course of artwork appraisal. In the art trade market, an authentic artwork may be identified by presenting a certificate of authenticity, which is usually provided by an art dealer. However, such certificate of authenticity is not reliable because it is usually a piece of paper and can be easily lost or forged, and is therefore difficult to be treated as a trustworthy means to prevent art forgery.

### SUMMARY OF THE INVENTION

The primary purpose of the present invention is to produce an RFID tag, which is integrated into the pattern of artworks, such as paintings, ceramics, statues and etc., without influencing the appearance of the artworks aesthetically, and can be identified by RFID readers to obtain identification and relevant information of the RFID tag.

In order to accomplish the aforementioned purpose, a method for manufacturing the RFID tag includes steps of:

selectively coating a watertight layer on a periphery of the artwork;

printing a conductive ink on a surface of a polyethylene terephthalate film;

heating the printed conductive ink on the surface of the polyethylene terephthalate film at a temperature 50° C. for 33 minutes, and curing the conductive ink as an antenna of the RFID tag;

removing the antenna from the polyethylene terephthalate film to be packaged as the RFID tag with an RFID chip;

pasting the RFID tag on the periphery of the artwork with AB adhesive provided on an interface between the RFID tag and the artwork; and

coating a protective layer on a periphery of the RFID tag to prevent exposure to the air.

### BRIEF DESCRIPTION OF THE DRAWINGS

The present invention, as well as many advantages thereof, may be further elaborated and illustrated by the following detailed description and drawings in which:

FIG. 1 is a flow chart showing a method of manufacturing an RFID tag integrated to a surface of ceramics in accordance with the present invention; and

FIG. 2 is a schematic cross-sectional view showing an RFID tag in accordance with the present invention.

### DETAILED DESCRIPTION OF THE INVENTION

RFID is an automatic identification method and can be carried out by an RFID tag for storing specific information, an RFID reader capable of receiving a wireless signal from the RFID tag and a processor connected to the RFID reader to receive and decode the wireless signal to obtain the information stored in the RFID tag. Furthermore, the RFID tag basically has an antenna and a microchip electrically connected to the antenna. Unlike barcode scanning, RFID is a more convenient identification method to be carried out when the RFID tag and the RFID reader mutually communicate, meaning that identification can be accomplished as long as the RFID reader is located in an effective range to receive the wireless signal from the RFID tag.

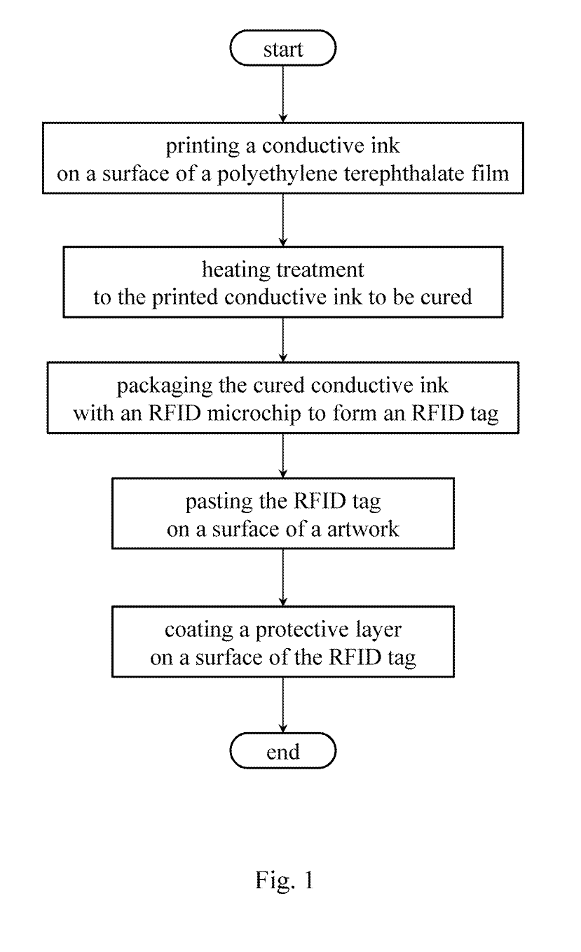

With reference to FIG. 1, a method shows steps for manufacturing an RFID tag on an artwork in accordance with the invention. It is noted that, the artwork includes, but is not limited to, a china, which is used as an instance of the artwork in the following description.

To produce a RFID tag, a mesh screen with an unblocked area defined by a desired shape of the antenna on the mesh screen is the first to be prepared. As being conventional in the art of screen printing, the detail description of the mesh screen is omitted. In the present embodiment, the mesh screen has three hundred meshes, and a blade for printing ink is provided and moves at a speed 150 mm/s toward the mesh screen. The ink is a conductive ink, which may be silver and copper and is selected as added pigment to mix a desired color.

A polyethylene terephthalate (PET) film is prepared with a thickness of 0.1 mm and is printed with the ink on a surface thereof via the aforementioned screen printing. Under certain circumstance, the ink may be too viscous to be easily moved on the mesh screen, such that a thinner ink is selectively used to make the ink move smoothly.

After the antenna is printed, a heating treatment is provided at a temperature 50° C. for 33 minutes to cure the ink and form the antenna.

After the heating treatment is completed, the antenna is removed from the PET film and is packaged with the microchip electrically connected thereto to form the RFID tag, and then the RFID tag is pasted on a periphery of the china with AB adhesive provided on an interface between the RFID tag and the china. With respect to the design of the china, the RFID tag may be affixed on a bottom surface of the china or on a side surface of the china, and can be further integrated into a pattern of the china, so as to hide the RFID tag without influencing the china aesthetically.

In addition, a watertight layer is selectively coated on the periphery of the china, especially if the china has pores that moisture may penetrate to oxidize the circuit. Moreover, if an uranium material is coated on the periphery of the china, this material is capable of absorbing electromagnetic interference and can be used as an isolated layer between the interface of the RFID tag and the china.

As the RFID tag is still exposed to the air after being pasted on the china and the moisture in the air may oxidize the circuit, a protective layer is further coated to cover the RFID tag with acryl, thereby avoiding occurrence of oxidation and penetration of external pollution.

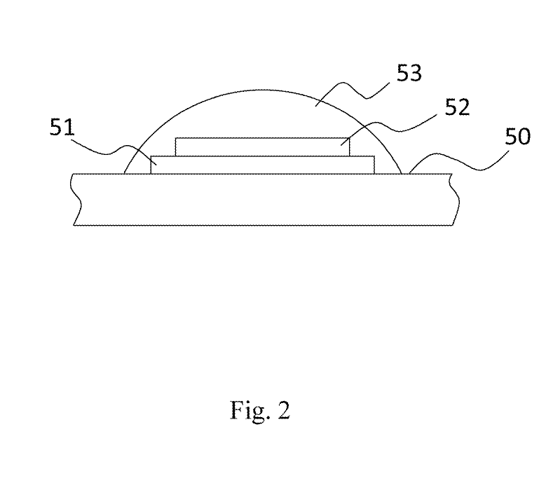

With reference to FIG. 2, a schematic cross-sectional view shows the side profile of the RFID tag pasted on the china by the aforementioned steps. The china 50 is coated with the watertight layer 51 on the periphery thereof, the RFID tag 52 is pasted on the watertight layer 51, and the protective layer 53 is coated on the periphery of the RFID tag to prevent exposure to the air.

When an artwork is completed, an identification code related to the artwork can be stored in the microchip to be packaged in the RFID tag and to be readable by the RFID reader. The processor receives the identification code from the RFID reader and outputs an introduction of the corresponding artwork, such as design concept or idea of the artwork, author's profile and etc., which are pre-stored in a data base. The foregoing application is achievable by a mobile phone or a PC (personal computer) with built-in RFID or NFC (near field communication) features. User can operate the mobile phone or the PC to download the information of the browsed artworks while visiting museums or exhibitions. The present invention is advantageous in that the RFID tag not only can be integrated into the appearance of each artwork, but also can confer an exclusive identification to the artwork.

Many changes and modifications in the above described embodiment of the invention are able to, of course, be carried out without departing from the scope thereof. Accordingly, to promote the progress in science and the useful arts, the invention is disclosed and is intended to be limited only by the scope of the invention.

What is claimed is:

1. A method for manufacturing an RFID tag integrated into an artwork comprising steps of:
selectively coating a watertight layer on a periphery of the artwork;
printing a conductive ink on a surface of a polyethylene terephthalate film;
heating the printed conductive ink on the surface of the polyethylene terephthalate film at a temperature 50° C. for 33 minutes, and curing the conductive ink as an antenna of the RFID tag;
removing the antenna from the polyethylene terephthalate film to be packaged as the RFID tag with an RFID chip;
pasting the RFID tag on the periphery of the artwork with an adhesive provided on an interface between the RFID tag and the artwork; and
coating a protective layer on a periphery of the RFID tag to prevent exposure to the air.

2. The method for manufacturing an RFID tag integrated into an artwork as claimed in claim 1 further comprising selectively forming an isolated layer between the RFID tag and the artwork with a material capable of absorbing electromagnetic.

3. The method for manufacturing an RFID tag integrated into an artwork as claimed in claim 2, wherein the conductive ink contains a conductive material being silver or copper.

4. The method for manufacturing an RFID tag integrated into an artwork as claimed in claim 3, wherein the conductive ink is selected as added pigment to mix a desired color.
